(19) United States
(12) Patent Application Publication
(10) Pub. No.: US 2024/0163633 A1
(43) Pub. Date: May 16, 2024

(54) SOUND SIGNAL PROCESSING METHOD, DEVICE, ELECTRONIC EQUIPMENT AND STORAGE MEDIUM

(71) Applicant: Beijing Zitiao Network Technology Co., Ltd., Beijing (CN)

(72) Inventors: Ziyuan LIU, Beijing (CN); Zhanyi YAN, Beijing (CN); Qian LIN, Beijing (CN)

(21) Appl. No.: 18/389,523

(22) Filed: Nov. 14, 2023

(30) Foreign Application Priority Data
Nov. 15, 2022 (CN) 202211431502.0

(51) Int. Cl. H04S 7/00; G02B 27/01; H04R 1/08

(52) U.S. Cl. CPC H04S 7/40; G02B 27/0172; H04R 1/083; G02B 2027/014; G02B 2027/0141; H04R 2499/15; H04S 2400/15

(57) ABSTRACT

The embodiments of the present disclosure relate to a sound signal processing method, device, electronic equipment and storage medium. The method is used for a head-mounted display apparatus and includes: acquiring an ambient sound signal of the head-mounted display apparatus, identifying the ambient sound signal and determining a sound category corresponding to the ambient sound signal, and displaying corresponding prompt information in the head-mounted display apparatus according to the sound category.

### CROSS-REFERENCE TO RELATED APPLICATION

The present application claims priority to Chinese Patent Application No. CN 202211431502.0, filed on Nov. 15, 2022, which is incorporated herein by reference in its entirety.

### TECHNICAL FIELD

The present disclosure relates to the technical field of information processing, in particular to a sound signal processing method, device, electronic equipment and storage medium.

### BACKGROUND

Usually, people with hearing impairment can't hear dangerous sound sources in a physical environment, such as a sharp car honking sound when crossing a road, an earthquake alarm sound when an earthquake is coming, a fire alarm sound when a fire emergency occurs, a police siren sound or a sharp shouting sound when there are dangerous situations around, a sound of an ambulance coming when someone is injured around, and the like.

In the related art, a user is prompted by wearing a sound recognition device, for example, the sound recognition device recognizes a sound and gives out a prompt. However, it cannot remind the user what the recognized sound is, and the judgment is not accurate or intuitive enough, resulting in that the user will not be able to distinguish what exactly happened in a complex environment, for example, if there is a car honking sound in the road while someone is sharply quarreling around.

### SUMMARY

In order to solve or at least partially solve the technical problems above, the present disclosure provides a sound signal processing method, device, electronic equipment and storage medium.

The embodiment of the present disclosure provides a sound signal processing method, including steps of:
acquiring an ambient sound signal of the head-mounted display apparatus;
identifying the ambient sound signal and determining a sound category corresponding to the ambient sound signal; and
displaying corresponding prompt information in the head-mounted display apparatus according to the sound category.

The embodiment of the present disclosure also provides a sound signal processing device, including:
an acquisition module, configured to acquire an ambient sound signal of the head-mounted display apparatus;
a processing module, configured to identify the ambient sound signal and determine a sound category corresponding to the ambient sound signal; and
a display module, configured to display corresponding prompt information in the head-mounted display apparatus according to the sound category.

The embodiment of the present disclosure also provides an electronic equipment, including a processor; and a memory configured for storing instructions executable by the processor; wherein the processor is configured to read the executable instructions from the memory and execute the instructions to implement the sound signal processing method provided by the embodiment of the present disclosure.

The embodiment of the present disclosure also provides a computer-readable storage medium having a computer program stored therein, and the computer program is configured to execute the sound signal processing method provided by the embodiment of the present disclosure.

Compared with the prior art, the technical solutions provided by the embodiment of the present disclosure have the following advantages: the sound signal processing solution provided by the embodiment of the present disclosure obtains the ambient sound signal of the head-mounted display apparatus, identifies the ambient sound signal, determines the sound category corresponding to the ambient sound signal, and displays the corresponding prompt information in the head-mounted display apparatus according to the sound category. By adopting the technical solution above, the head-mounted display apparatus provides users such as hearing-impaired people with particularly classified sound alarms, so that the users can quickly identify the sound category and that the safety requirements of users such as hearing-impaired people can be satisfied; in this way, it enables the users to identify a danger by displaying the sound category on the head-mounted display apparatus in an intuitive real-time reminding way, thereby further improving the diversity and effectiveness in sound signal processing scenarios.

### BRIEF DESCRIPTION OF THE DRAWINGS

The above and other features, advantages and aspects of embodiments of the present disclosure will become more apparent with reference to the following particular embodiments in conjunction with the accompanying drawings. Throughout the drawings, the same or similar reference numerals indicate the same or similar elements. It should be understood that the drawings are schematic, and the components and elements are not necessarily drawn to scales.

FIG. 1 is a flowchart of a sound signal processing method provided by an embodiment of the present disclosure;

FIG. 2 is a flowchart of another sound signal processing method provided by an embodiment of the present disclosure;

FIG. 3 is a schematic diagram of an information display provided by an embodiment of the present disclosure;

FIG. 4 is a schematic diagram of another information display provided by an embodiment of the present disclosure;

FIG. 5 is a schematic structural diagram of a sound signal processing device provided by an embodiment of the present disclosure; and

FIG. 6 is a schematic structural diagram of an electronic equipment provided by an embodiment of the present disclosure.

### DETAILED DESCRIPTION

Embodiments of the present disclosure will be described in more details below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “comprising/including” and its variants are open-ended, that is, “including but not limited to”. The term “based on” refers to “at least partially based on”. The term “one/an embodiment” means “at least one embodiment”. The term “another embodiment” means “at least one other embodiment”. The term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the qualifiers such as “a/one” and “a plurality of” mentioned in the present disclosure are schematic rather than limitative, and those skilled in the art should understand that unless the context clearly indicates otherwise, they should be understood as “one or more”.

Names of messages or information exchanged among multiple devices in the embodiments of the present disclosure are only used for illustrative purposes, and are not used to limit the scope of these messages or information.

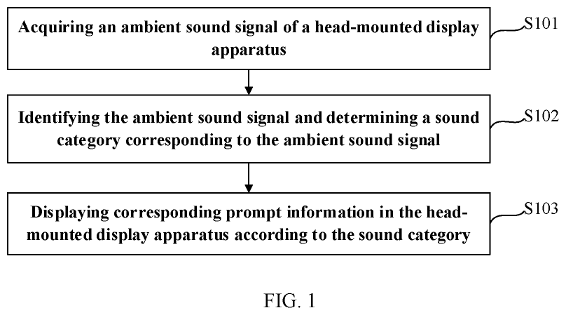

FIG. 1 is a flowchart of a sound signal processing method provided by an embodiment of the present disclosure. The method can be executed by a sound signal processing device, and the device can be implemented by software and/or hardware and generally can be integrated in an electronic equipment. As shown in FIG. 1, the method includes:

Step 101: acquiring an ambient sound signal of a head-mounted display apparatus.

The head-mounted display apparatus refers to an apparatus which is worn by a user and has a display interface and a device for collecting sound signals. For example, it may be eyeglasses having lenses as the display interface and including a sound collection device such as a microphone array. The embodiment of the present disclosure does not specifically limit the form of the head-mounted display apparatus. The ambient sound signal refers to sound information of a belonging environment of the head-mounted display apparatus, and the belonging environment refers an environment where the head-mounted display apparatus is located. For example, if the user wears eyeglasses in a bedroom, the belonging environment refers to the bedroom, and if the user wears eyeglasses and takes a walk outdoors, the belonging environment refers to the outdoor environment. In the embodiment of the present disclosure, the belonging environment refers to a space area where the head-mounted display apparatus can receive sound signals.

In the embodiment of the present disclosure, there are many ways to acquire the ambient sound signal of the head-mounted display apparatus. In some embodiments, a sound signal for a preset time duration is acquired through a sound receiving device of the head-mounted display apparatus, and the acquired sound signal is detected to obtain a sound signal with a timestamp and a confidence, and the sound signal corresponding to a target timestamp with a confidence greater than a confidence threshold is determined as the ambient sound signal.

In some other embodiments, the head-mounted display apparatus receives a sound signal for a preset time duration in real time in its belonging environment, and directly intercepts the received sound signal to obtain a sound signal used as the ambient sound signal.

That is to say, the received sound signal can be detected and then used as the ambient sound signal for subsequent identification of sound category, or, the received sound signal can be directly used as the ambient sound signal for subsequent identification, which can be particularly selected and set according to the application scenario.

The above are only two examples of acquiring the ambient sound signal of the head-mounted display apparatus, and the embodiment of the present disclosure does not specifically limit the way of acquiring the ambient sound signal of the head-mounted display apparatus.

Specifically, when the user wears the head-mounted display apparatus, the sound receiving device in the head-mounted display apparatus, such as the microphone array, detects and acquires the ambient sound signal of the belonging environment in real time.

Step 102: identifying the ambient sound signal and determining a sound category corresponding to the ambient sound signal.

It should be noted that, in order to further satisfy the usage requirements of users, the users can be supported to update a sound database by inputting sound signal samples through related operations, so that the personalized requirements of users can be improved.

The sound category includes one or more of a car honking sound, a police siren sound, a fire alarm sound and the like.

In the embodiment of the present disclosure, there are many ways to identify the ambient sound signal and determine the sound category corresponding to the ambient sound signal. In some embodiments, the ambient sound signal is compared with a plurality of categories of sound signal samples in a sound database to obtain a target sound signal sample corresponding to the ambient sound signal, and the sound category is determined based on a category of the target sound signal sample.

The sound database is set in advance. Specifically, sound signal samples of different sound categories are obtained in advance and stored so as to obtain the sound database in which car honking sound signal samples, police siren sound signal samples, fire alarm sound signal samples and the like are stored.

In some other embodiments, a feature extraction is performed on the ambient sound signal to obtain a target feature, and a feature category matching is performed in the sound database to obtain a sound category matched with the target feature. In the sound database, correspondence relationships between different sound features and sound categories are stored.

The above two ways are only two examples of identifying the ambient sound signal and determining the sound category corresponding to the ambient sound signal. The embodiment of the present disclosure does not specifically limit the way of identifying the ambient sound signal and determining the sound category corresponding to the ambient sound signal.

In the embodiment of the present disclosure, after acquiring the ambient sound signal of the head-mounted display apparatus, the ambient sound signal can be identified, and the sound category corresponding to the ambient sound signal can be determined; there may be a plurality of sound categories.

Step 103: displaying corresponding prompt information in the head-mounted display apparatus according to the sound category.

Different sound categories correspond to different prompt information. For example, the prompt information includes one or more of a road danger, an earthquake danger, a fire danger, a crowd danger and a surrounding danger.

Specifically, after the sound category is obtained, the sound category can be displayed on a display interface of the head-mounted display apparatus. In the embodiment of the present disclosure, there are many ways to display the corresponding prompt information in the head-mounted display apparatus according to the sound category. In some embodiments, a sound icon corresponding to the sound category is obtained and displayed on the head-mounted display apparatus. In some other embodiments, a sound icon and text information corresponding to the sound category are obtained and displayed on the head-mounted display apparatus.

The above two ways are only examples of displaying the corresponding prompt information in the head-mounted display apparatus according to the sound category, and the embodiment of the present disclosure does not specifically limit the way of displaying the corresponding prompt information in the head-mounted display apparatus according to the sound category.

According to the sound signal processing solution provided by the embodiment of the present disclosure, the ambient sound signal of the head-mounted display apparatus is obtained and identified to determine corresponding sound category, and corresponding prompt information is displayed in the head-mounted display apparatus according to the sound category. By adopting the technical solution above, the head-mounted display apparatus provides particularly classified sound alarms for users such as hearing-impaired people, so that the users can quickly identify the sound categories and that the safety requirements of users such as hearing-impaired people can be satisfied; in this way, it enables the users to identify a danger by displaying the sound category on the head-mounted display apparatus in an intuitive real-time reminding way, thereby further improving the diversity and effectiveness in sound signal processing scenarios.

In some embodiments, acquiring the ambient sound signal of the head-mounted display apparatus includes: acquiring a sound signal for a preset time duration through a sound receiving device of the head-mounted display apparatus, detecting the acquired sound signal to obtain a sound signal with a timestamp and a confidence, and determining the sound signal that corresponds to a target timestamp as the ambient sound signal, wherein the target timestamp has a confidence greater than a confidence threshold.

The preset time duration can be set according to the application scenario, for example, 5 seconds, 10 seconds, and the like. It can be understood that if the received sound signal is directly used as the ambient sound signal, there may be errors in subsequent processing. In order to further improve the accuracy of the prompt, in the embodiment of the present disclosure, a sound signal with a timestamp and a confidence is obtained by detecting the received sound signal, and the sound signal that corresponds to a target timestamp is determined as the ambient sound signal, wherein the target timestamp has a confidence greater than a confidence threshold. The confidence threshold can be set according to the application scenario.

Specifically, an event in the acquired sound signal is detected, and a confidence and a timestamp (indicative of position information) are obtained. That is to say, the input is a sound signal, and the output is a confidence and a timestamp with a detection time. The processing of the sound signal can include a comprehensive detection of sound understanding, language recognition, attribution recognition, human voice separation and the like, so as to obtain a sound signal with timestamp and confidence.

In the above solution, the received sound signal is detected, and a sound signal that corresponds to a timestamp with a higher confidence is obtained and used as the signal to be processed for subsequent identification of sound category, thereby further increasing the accuracy of sound signal processing, satisfying the user's usage requirements and improving the user's usage experience.

In some embodiments, the sound receiving device includes a microphone array, and a sound direction is determined according to the sound signal acquired by the microphone array.

Specifically, receiving a sound signal based on a microphone array at a first position in the head-mounted display apparatus, and receiving a sound signal based on a microphone array at a second position in the head-mounted display apparatus, with the second position and the first position being arranged symmetrically; receiving a sound signal based on a microphone array at a third position in the head-mounted display apparatus, with the third position and the second position being spaced apart from each other by a target distance; obtaining a sound direction based on the first position, the second position and the third position; and displaying the sound direction based on the head-mounted display apparatus.

A plurality of microphone arrays is arranged in the head-mounted display apparatus in advance, and a position (that is, the position of the device or person who sends out the sound signal) corresponding to the sound signal can be obtained through a calculation based on the positions corresponding to different microphone arrays. In the embodiment of the present disclosure, it refers to a position relative to the user wearing the head-mounted display apparatus, that is, a relative position, such as the upper left, the rear right, etc.; particularly, it may be a relative angle.

The settings of the first position, the second position and the third position can also be adjusted according to the application scenarios or the number of the microphone arrays, so as to satisfy the requirements of actual application scenarios.

In the embodiment of the present disclosure, after obtaining the sound direction, the sound direction can be displayed on the head-mounted display apparatus. For example, an orientation icon corresponding to the sound direction can be obtained, so that the orientation icon and the sound category obtained in the previous embodiment can be displayed on the display interface of the head-mounted display apparatus.

In the above solution, the sound direction is determined by the sound receiving device that obtains the sound signal, so that the sound direction and the sound category can be displayed at the same time, which further helps the user to respond to the prompt, thereby accurately reminding the user and satisfying the user's requirements.

In some embodiments, identifying the ambient sound signal and determining the sound category corresponding to the ambient sound signal includes: comparing the ambient sound signal with a plurality of categories of sound signal samples in a preset sound database to obtain a target sound signal sample corresponding to the ambient sound signal, and obtaining the sound category based on a category of the target sound signal sample.

The plurality of categories of sound signal samples may include, for example, car honking sound signal samples, police siren sound signal samples, fire alarm sound signal samples and so on.

In the embodiment of the present disclosure, the ambient sound signal is compared with a plurality of categories of sound signal samples in the sound database, and the target sound signal sample corresponding to the ambient sound signal can be understood as a sound signal belonging to the same sound category with the ambient sound signal. Therefore, the category of the target sound signal sample is obtained as the sound category, and then the corresponding prompt information, such as a road danger, an earthquake danger, a fire danger, a crowd danger and a surrounding danger, is displayed in the head-mounted display apparatus according to the sound category.

By adopting the above solution, the sound category is determined by comparing the ambient sound signal with a plurality of categories of sound signal samples in the sound database, so that the sound category can be accurately determined and the safety requirements of hearing-impaired people can be satisfied.

In some embodiments, a sound level is determined based on the ambient sound signal and a preset volume threshold, and the sound level is displayed based on the head-mounted display apparatus.

The volume threshold can be set according to the requirements of application scenarios.

In the embodiment of the present disclosure, there are many ways to determine the sound level based on the ambient sound signal and the preset volume threshold. In some embodiments, the volume threshold includes a first volume threshold, a second volume threshold and a third volume threshold, with the first volume threshold being greater than the second volume threshold, and the second volume threshold being greater than the third volume threshold. Determining the sound level based on the ambient sound signal and the preset volume threshold includes: determining the sound level as a first sound level when a volume of the ambient sound signal is greater than the first volume threshold, determining the sound level as a second sound level when the volume of the ambient sound signal is smaller than the first volume threshold and greater than the second volume threshold, and determining the sound level as a third sound level when the volume of the ambient sound signal is smaller than the second volume threshold and greater than the third volume threshold.

In another embodiment, when the volume of the ambient sound signal is greater than a volume threshold, it is determined that the sound level is the first sound level, and when the volume of the ambient sound signal is smaller than or equal to the volume threshold, it is determined that the sound level is the second sound level.

The above two ways are only examples of determining the sound level based on the ambient sound signal and the preset volume threshold, and the embodiment of the present disclosure does not specifically limit the way of determining the sound level based on the ambient sound signal and the preset volume threshold.

In the embodiment of the present disclosure, there are many ways to display the sound level based on the head-mounted display apparatus. In some embodiments, a display color is determined based on the sound level, and the sound category and the sound direction are displayed according to the display color. In another way, a display color and a vibration amplitude are determined based on the sound level, and the sound category and the sound direction are displayed according to the display color while the head-mounted display apparatus being controlled to vibrate according to the vibration amplitude.

In the above solution, the sound level can be determined based on the ambient sound signal and the preset volume threshold, so that the sound category, the sound direction and the sound level can be comprehensively displayed to the user, and that the user can intuitively identify a danger in the fastest and most intuitive way.

In some embodiments, the head-mounted display apparatus prompts for the sound direction, the sound category and the sound level by determining a sound icon and text information based on the sound category, determining an orientation icon based on the sound direction, determining a display color and a vibration amplitude based on the sound level, and displaying the orientation icon, the sound icon and the text information on the display interface of the head-mounted display apparatus according to the display color while controlling the head-mounted display apparatus to vibrate according to the vibration amplitude.

The sound icon, the text information, the orientation icon, the display color and the vibration amplitude can be set according to the user's usage habits. For example, green color may be used to indicate the lowest sound level and red color may be used to indicate the highest sound level. For another example, the minimum vibration amplitude may be used to indicate the lowest sound level, and the maximum vibration amplitude may be used to indicate the highest sound level.

By adopting the above solution, the sound category, the sound direction and the sound level can be displayed to the user at the same time, so that the user can quickly identify the sound category, the sound direction and the sound level, and that the safety requirements of hearing-impaired people can be satisfied.

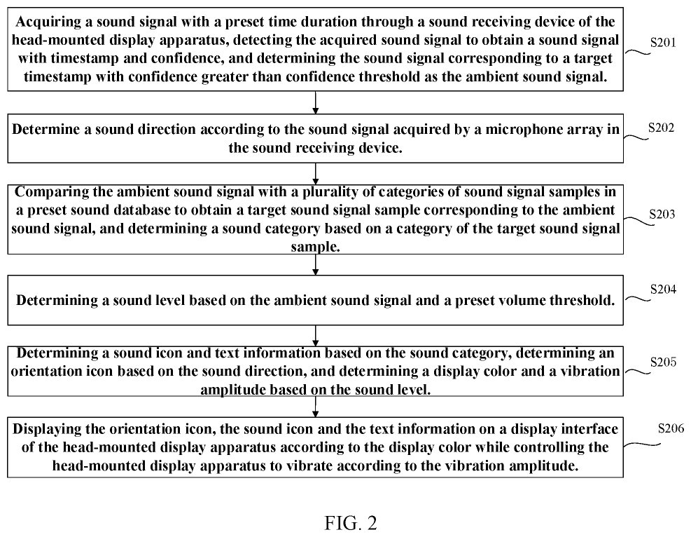

FIG. 2 is a flowchart of another sound signal processing method provided by an embodiment of the present disclosure. This embodiment further optimizes the above sound signal processing method on the basis of the above embodiment. As shown in FIG. 2, the method includes:

Step 201: acquiring a sound signal for a preset time duration through a sound receiving device of the head-mounted display apparatus, detecting the acquired sound signal to obtain a sound signal with a timestamp and a confidence, and determining a sound signal that corresponds to a target timestamp as the ambient sound signal, the target timestamp having a confidence greater than a confidence threshold.

Specifically, the embodiment of the present disclosure summarizes common sound signals such as dangerous sound signals, and collects dangerous sound sources to obtain the categories of the dangerous sound sources, so that hearing-impaired users can know exactly what the surrounding dangerous situation is.

Specifically, an event in the acquired sound signal is detected to obtain a confidence and a timestamp (position information), and a sound signal corresponding to a target timestamp is taken as the ambient sound signal, wherein the target timestamp has a confidence greater than the confidence threshold.

Step 202: determine a sound direction according to the sound signal acquired by a microphone array in the sound receiving device.

Specifically, a specific sound orientation is obtained from the arrangement of the microphone array. For example, 0-180 degrees can be divided into 36 sound zones, and a location angle is obtained at where the maximum energy is achieved. Through many times of experiments and comparative analysis, the array is configured such that: when a head-mounted display apparatus such as eyeglasses is worn, a microphone 1 is located on a right temple and is 50 mm away from a front frame, for example; a microphone 2 is symmetrical with the microphone 1, located on a left temple, and is also 50 mm away from the front frame, for example; a microphone 3 is located on the left temple, and is 70 mm away from the front frame and 20 mm away from the microphone 2, for example; in this way, the orientation of sound generation can be obtained by calculation.

Step 203: comparing the ambient sound signal with a plurality of categories of sound signal samples in a preset sound database to obtain a target sound signal sample corresponding to the ambient sound signal, and determining the sound category based on a category of the target sound signal sample.

Specifically, for example, five sound categories are summarized, i.e., a road sound, an earthquake sound, a fire sound, a crowd sound and a surrounding sound. At the same time, the sound signal samples and the sound categories are in one-to-one correspondence, and the corresponding sounds can be learned, including a car honking sound, an earthquake alarm sound, a fire alarm sound, a shouting sound, and a sound of ambulance/police car/fire truck. When the microphone of the head-mounted display apparatus such as eyeglasses recognizes a sound having been learned, a danger reminder with one-to-one mapping relationship is carried out. Therefore, hearing-impaired users can avoid the corresponding risks when they receive such reminder.

Specifically, the ambient sound signal is compared with the dangerous sound signal samples in the preset sound database; for example, it may be consistent with a honking sound signal sample in the sound database, consistent with an earthquake alarm sound signal sample in the sound database, consistent with a fire alarm sound signal sample in the sound database, consistent with a shouting sound signal sample in the sound database, and consistent with an ambulance/police car/fire truck sound signal sample in the sound database.

Step 204: determining a sound level based on the ambient sound signal and a preset volume threshold.

Specifically, the volume threshold includes a first volume threshold, a second volume threshold and a third volume threshold, wherein the first volume threshold is greater than the second volume threshold, and the second volume threshold is greater than the third volume threshold. Determining the sound level based on the ambient sound signal and the preset volume threshold includes: determining the sound level as a first sound level when a volume of the ambient sound signal is greater than the first volume threshold, determining the sound level as a second sound level when the volume of the ambient sound signal is smaller than the first volume threshold and greater than the second volume threshold, and determining the sound level as a third sound level when the volume of the ambient sound signal is smaller than the second volume threshold and greater than the third volume threshold.

Step 205: determining a sound icon and text information based on the sound category, determining an orientation icon based on the sound direction, and determining a display color and a vibration amplitude based on the sound level.

Step 206: displaying the orientation icon, the sound icon and the text information on a display interface of the head-mounted display apparatus according to the display color while controlling the head-mounted display apparatus to vibrate according to the vibration amplitude.

Specifically, the sound level is distinguished by color and vibration intensity, and the sound level depends on the volume of the sound. The larger the volume, the greater the vibration, and the more vivid display color is used for prompting.

As an example of a scenario, when a hearing-impaired user walks on the sidewalk and a honking sound of an electric car for delivery is generated from the right rear, the hearing-impaired user can't hear this sound, and the delivery staff is too anxious to brake, which leads to an injury risk for the hearing-impaired user. After wearing a head-mounted display apparatus such as eyeglasses, since the eyeglasses will display the honking sound at the right rear, the hearing-impaired user can make an avoidance in time to prevent from injuries.

As an example of another scenario, when the hearing-impaired user is in a restaurant or entertainment place and a fire breaks out, wearing a head-mounted display apparatus such as eyeglasses enables the user to know the current situation immediately, find a wet towel to cover his/her mouth and nose, and quickly escape from the scenario.

Therefore, when the user intuitively understands the current dangerous situation, he/she can make decision on the next action in time.

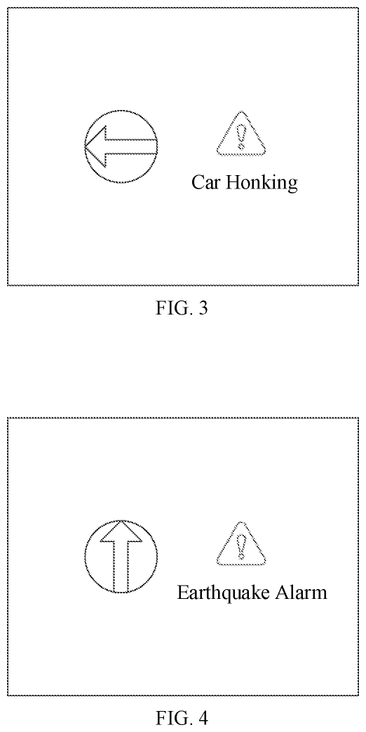

By way of example, FIG. 3 is a schematic diagram of information display provided by an embodiment of the present disclosure. After determining the sound direction, the sound category and the sound level, as shown in FIG. 3, the sound direction icon is displayed as a left parallel position, the sound category icon is displayed as a triangle including an exclamation point prompt, and the text information is displayed as “honking sound”; and at the same time, the sound level is prompted through related display color and vibration.

By way of example, FIG. 4 is a schematic diagram of another information display provided by an embodiment of the present disclosure. After determining the sound direction, the sound category and the sound level, as shown in FIG. 4, the sound direction icon is displayed as a straight-ahead position, the sound category icon is displayed as a triangle including an exclamation point prompt, and the text information is displayed as “earthquake alarm”; and at the same time, the sound level is prompted through related display color and vibration.

According to the sound signal processing solution provided by the embodiment of the present disclosure, a sound signal for a preset time duration is acquired through a sound receiving device of a head-mounted display apparatus, the acquired sound signal is detected to obtain a sound signal with a timestamp and a confidence, and the sound signal that corresponds to a target timestamp with a confidence greater than a confidence threshold is determined as an ambient sound signal. The sound signal is received based on a microphone array at a first position in the head-mounted display apparatus, the sound signal is received based on a microphone array at a second position in the head-mounted display apparatus, with the second position and the first position being symmetrically arranged, and the sound signal is received based on a microphone array at a third position in the head-mounted display apparatus, with the third position and the second position being spaced apart from each other by a target distance; then a sound direction is determined based on the first position, the second position and the third position. The ambient sound signal is compared with a plurality of categories of sound signal samples in a preset sound database, a target sound signal sample corresponding to the ambient sound signal is obtained, and a sound category is determined based on a category of the target sound signal sample. A sound level is determined based on the ambient sound signal and a preset volume threshold. A sound icon and text information are determined based on the sound category, an orientation icon is determined based on the sound direction, and a display color and a vibration amplitude are determined based on the sound level. The orientation icon, the sound icon and the text information are displayed on a display interface of the head-mounted display apparatus according to the display color; and at the same time, the head-mounted display apparatus is controlled to vibrate according to the vibration amplitude. By adopting the technical solution above, particularly classified danger alarms are provided for the hearing-impaired people with the head-mounted display apparatus, so that the user can quickly identify the sound category, the safety of the hearing-impaired people can be guaranteed in a better way, and the user is enabled to intuitively identify the danger in the fastest and most intuitive way; moreover, the sound category, the sound direction and the sound level can be comprehensively displayed to the user, and the diversity and effectiveness in the sound signal processing scenario are further improved.

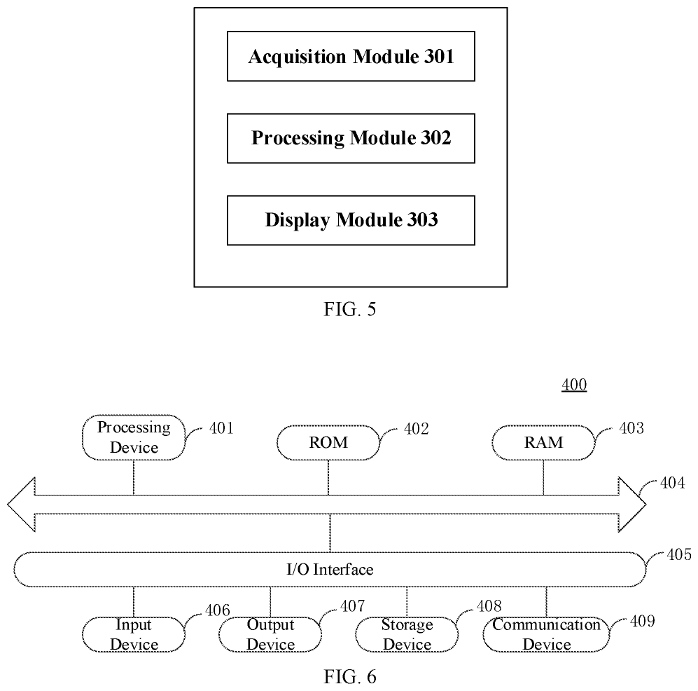

FIG. 5 is a schematic structural diagram of a sound signal processing device provided by an embodiment of the present disclosure. The device can be implemented by software and/or hardware, and can be generally integrated in electronic equipment. As shown in FIG. 5, the sound signal processing device includes:

an acquisition module 301, configured to acquire an ambient sound signal of the head-mounted display apparatus;

a processing module 302, configured to identify the ambient sound signal and determine a sound category corresponding to the ambient sound signal; and

a display module 303, configured to display corresponding prompt information in the head-mounted display apparatus according to the sound category.

Optionally, the obtaining module 301 is specifically configured to:
acquire a sound signal for a preset time duration through a sound receiving device of the head-mounted display apparatus;
detect the acquired sound signal to obtain a sound signal with a timestamp and a confidence; and
determine the sound signal that corresponds to a target timestamp as the ambient sound signal, wherein the target timestamp has a confidence greater than a confidence threshold.

Optionally, the sound receiving device includes a microphone array, and the sound signal processing device further includes:
a first determination module, configured to determine a sound direction according to the sound signal acquired by the microphone array.

Optionally, the processing module 302 is specifically configured to:
compare the ambient sound signal with a plurality of categories of sound signal samples in a preset sound database;
acquire a target sound signal sample corresponding to the ambient sound signal; and
determine a sound category based on a category of the target sound signal sample.

Optionally, the sound signal processing device further includes:
a second determination module, configured to determine a sound level based on the ambient sound signal and a preset volume threshold; and
the display module 303 is further configured to display the sound level based on the head-mounted display apparatus.

Optionally, the volume threshold includes a first volume threshold, a second volume threshold and a third volume threshold, wherein the first volume threshold is greater than the second volume threshold, and the second volume threshold is greater than the third volume threshold. The second determination module is specifically configured to:
determine that the sound level is a first sound level when the volume of the ambient sound signal is greater than the first volume threshold;
determine that the sound level is a second sound level when the volume of the ambient sound signal is smaller than the first volume threshold and greater than the second volume threshold; and
determine that the sound level is a third sound level when the volume of the ambient sound signal is smaller than the second volume threshold and greater than the third volume threshold.

Optionally, the display module 303 is specifically configured to:
determine a sound icon and text information based on the sound category;
determine an orientation icon based on the sound direction;
determine a display color and a vibration amplitude based on the sound level; and
display the orientation icon, the sound icon and the text information on a display interface of the head-mounted display apparatus according to the display color; and at the same time, control the head-mounted display apparatus to vibrate according to the vibration amplitude.

The sound signal processing device provided by the embodiment of the present disclosure can execute the sound signal processing method provided by any embodiment of the present disclosure, and has corresponding functional modules and beneficial effects.

The embodiment of the present disclosure also provides a computer program product, including computer programs/instructions, which, when executed by a processor, implements the sound signal processing method provided by any embodiment of the present disclosure.

FIG. 6 is a schematic structural diagram of an electronic equipment provided by an embodiment of the present disclosure. Specifically, referring to FIG. 6, it shows a schematic structural diagram of an electronic equipment 400 suitable for implementing an embodiment of the present disclosure. The electronic equipment 400 in the embodiment of the present disclosure may include, but is not limited to, a mobile terminal such as a mobile phone, a notebook computer, a digital broadcast receiver, a personal digital assistant (PDA), a tablet computer (PAD), a portable multimedia player (PMP), a vehicle-mounted terminal such as a vehicle navigation terminal, and a fixed terminal such as a digital TV and a desktop computer. The electronic equipment shown in FIG. 6 is just an example, and should not bring any limitation to the function and application scope of the embodiment of the present disclosure.

As shown in FIG. 6, the electronic equipment 400 may include a processing device (such as a central processing unit, a graphics processor, etc.) 401, which may perform various appropriate actions and processes according to a program stored in a read-only memory (ROM) 402 or a program loaded from a storage device 408 into a random-access memory (RAM) 403. In the RAM 403, various programs and data required for the operation of the electronic equipment 400 are also stored. The processing device 401, the ROM 402 and the RAM 403 are connected to each other through a bus 404. An input/output (I/O) interface 405 is also connected to the bus 404.

Generally, the following devices can be connected to the I/O interface 405: an input device 406 including, for example, a touch screen, a touch pad, a keyboard, a mouse, a camera, a microphone, an accelerometer, a gyroscope, etc.; an output device 407 including, for example, a liquid crystal display (LCD), a speaker, a vibrator, etc.; a storage device 408 including, for example, a magnetic tape, a hard disk, etc.; and a communication device 409. The communication device 409 may allow the electronic equipment 400 to perform wireless or wired communication with other devices to exchange data. Although FIG. 6 shows an electronic equipment 400 provided with various devices, it should be understood that it is not required to implement or have all the devices as shown. More or fewer devices may alternatively be implemented or provided.

In particular, according to an embodiment of the present disclosure, the process described above with reference to the flowchart can be implemented as a computer software program. For example, the embodiment of the present disclosure includes a computer program product including a computer program carried on a non-transitory computer-readable medium, and the computer program contains program codes for executing the method shown in the flowchart. In such an embodiment, the computer program can be downloaded and installed online through the communication device 409, or installed from the storage device 408, or installed from the ROM 402. When executed by the processing device 401, the computer program performs the above functions defined in the sound signal processing method of the embodiment of the present disclosure.

It should be noted that the computer-readable medium described above in the present disclosure may be a computer-readable signal medium or a computer-readable storage medium or any combination of both. The computer-readable storage medium may be, for example, but not limited to, an electrical, magnetic, optical, electromagnetic, infrared, or semiconductor system, apparatus or device, or a combination of any of the above. More specific examples of the computer-readable storage media may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program, which may be used by or in combination with an instruction execution system, apparatus, or device. In the present disclosure, the computer-readable signal medium may include a data signal propagated in a baseband or as part of a carrier wave, in which computer-readable program codes are carried. This propagated data signal can take many forms, including but not limited to electromagnetic signals, optical signals, or any suitable combination of the above. The computer-readable signal medium may also be any computer-readable medium other than a computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic equipment or may also exist alone without being assembled into the electronic equipment.

The above-mentioned computer-readable medium carries one or more programs, and when the one or more programs are executed by the electronic equipment, the electronic equipment is caused to: acquire an ambient sound signal of the head-mounted display apparatus, identify the ambient sound signal, determine a sound category corresponding to the ambient sound signal, and display corresponding prompt information in the head-mounted display device according to the sound category.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, the present disclosure provides a sound signal processing method, including:
acquiring an ambient sound signal of the head-mounted display apparatus;
identifying the ambient sound signal and determining a sound category corresponding to the ambient sound signal;
displaying corresponding prompt information in the head-mounted display apparatus according to the sound category.

According to one or more embodiments of the present disclosure, in the sound signal processing method provided by the present disclosure, acquiring the ambient sound signal of the head-mounted display apparatus includes:
acquiring a sound signal for a preset time duration through a sound receiving device of the head-mounted display apparatus;
detecting the acquired sound signal to obtain a sound signal with a timestamp and a confidence; and
determining the sound signal that corresponds to a target timestamp with a confidence greater than a confidence threshold as the ambient sound signal.

According to one or more embodiments of the present disclosure, in the sound signal processing method provided by the present disclosure, the sound receiving device includes a microphone array, and the sound signal processing method further includes:
determining a sound direction according to the sound signal acquired by the microphone array.

According to one or more embodiments of the present disclosure, in the sound signal processing method provided by the present disclosure, identifying the ambient sound signal and determining the sound category corresponding to the ambient sound signal includes:

comparing the ambient sound signal with a plurality of categories of sound signal samples in a preset sound database;
acquiring a target sound signal sample corresponding to the ambient sound signal;
determining the sound category based on a category of the target sound signal sample.

According to one or more embodiments of the present disclosure, the sound signal processing method provided by the present disclosure further includes:
determining a sound level based on the ambient sound signal and a preset volume threshold; and
displaying the sound level based on the head-mounted display apparatus.

According to one or more embodiments of the present disclosure, in the sound signal processing method provided by the present disclosure, the volume threshold includes a first volume threshold, a second volume threshold and a third volume threshold, wherein the first volume threshold is greater than the second volume threshold, and the second volume threshold is greater than the third volume threshold. Determining the sound level based on the ambient sound signal and the preset volume threshold includes:
determining that the sound level is a first sound level when a volume of the ambient sound signal is greater than the first volume threshold;
determining that the sound level is a second sound level when the volume of the ambient sound signal is smaller than the first volume threshold and greater than the second volume threshold; and
determining that the sound level is a third sound level when the volume of the ambient sound signal is smaller than the second volume threshold and greater than the third volume threshold.

According to one or more embodiments of the present disclosure, in the sound signal processing method provided by the present disclosure, displaying the corresponding prompt information in the head-mounted display apparatus according to the sound category includes:
determining a sound icon and text information based on the sound category;
determining an orientation icon based on the sound direction;
determining a display color and a vibration amplitude based on the sound level; and
displaying the orientation icon, the sound icon and the text information on a display interface of the head-mounted display apparatus according to the display color, while controlling the head-mounted display apparatus to vibrate according to the vibration amplitude.

According to one or more embodiments of the present disclosure, the present disclosure provides a sound signal processing device, including:
an acquisition module, configured to acquire an ambient sound signal of the head-mounted display apparatus;
a processing module, configured to identify the ambient sound signal and determine a sound category corresponding to the ambient sound signal; and
a display module, configured to display corresponding prompt information in the head-mounted display apparatus according to the sound category.

According to one or more embodiments of the present disclosure, in the sound signal processing device provided by the present disclosure, the acquisition module is specifically configured to:
acquire a sound signal for a preset time duration through a sound receiving device of the head-mounted display apparatus;
detect the sound signal to obtain a sound signal with a timestamp and a confidence;
determine the sound signal that corresponds to a target timestamp with a confidence greater than a confidence threshold as the ambient sound signal.

According to one or more embodiments of the present disclosure, in the sound signal processing device provided by the present disclosure, the sound receiving device includes a microphone array, and the sound signal processing device further includes:
a first determination module, configured to determine a sound direction according to the sound signal acquired by the microphone array.

According to one or more embodiments of the present disclosure, in the sound signal processing device provided by the present disclosure, the processing module 302 is specifically configured to:
compare the ambient sound signal with a plurality of categories of sound signal samples in a preset sound database;
acquire a target sound signal sample corresponding to the ambient sound signal; and
determine the sound category based on a category of the target sound signal sample.

According to one or more embodiments of the present disclosure, in the sound signal processing device provided by the present disclosure, the sound signal processing device further includes:
a second determination module, configured to determine a sound level based on the ambient sound signal and a preset volume threshold; and
the display module is further configured to display the sound level based on the head-mounted display apparatus.

According to one or more embodiments of the present disclosure, in the sound signal processing device provided by the present disclosure, the volume threshold includes a first volume threshold, a second volume threshold and a third volume threshold, wherein the first volume threshold is greater than the second volume threshold, and the second volume threshold is greater than the third volume threshold. The second determination module is specifically configured to:
determine that the sound level is a first sound level when a volume of the ambient sound signal is greater than the first volume threshold;
determine that the sound level is a second sound level when the volume of the ambient sound signal is smaller than the first volume threshold and greater than the second volume threshold;
determine that the sound level is a third sound level when the volume of the ambient sound signal is smaller than the second volume threshold and greater than the third volume threshold.

According to one or more embodiments of the present disclosure, in the sound signal processing device provided by the present disclosure, the display module 303 is specifically configured to:
determine a sound icon and text information based on the sound category;
determine an orientation icon based on the sound direction;
determine a display color and a vibration amplitude based on the sound level; and
display the orientation icon, the sound icon and the text information on a display interface of the head-mounted display apparatus according to the display color; and at the same time, control the head-mounted display apparatus to vibrate according to the vibration amplitude.

According to one or more embodiments of the present disclosure, the present disclosure provides an electronic equipment, including:
a processor; and
a memory configured for storing instructions executable by the processor;
the processor is configured to read the executable instructions from the memory and execute the instructions to implement the sound signal processing method according to any of the above provided by the present disclosure.

According to one or more embodiments of the present disclosure, the present disclosure provides a computer-readable storage medium having a computer program stored therein, wherein the computer program is configured to perform the sound signal processing method according to any of the above provided by the present disclosure.

The description above is only the preferred embodiments of the present disclosure and the explanation of the applied technical principles. It should be understood by those skilled in the art that the disclosure scope involved in the present disclosure is not limited to the technical solutions constituted by the specific combination of the above technical features, but also covers other technical solutions constituted by any combination of the above technical features or their equivalent features without departing from the above disclosure concept, for example, the technical solutions constituted by (but not limited to) replacing the above features with other technical features having similar functions disclosed in the present disclosure.

Furthermore, although the operations are depicted in a particular order, this should not be understood as requiring that these operations be performed in the particular order as shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in languages specific to structural features and/or methodological logical acts, it should be understood that the subject matter defined in the appended claims is not necessarily limited to the specific features or acts described above. On the contrary, the specific features and actions described above are only exemplary forms of implementing the claims.

What is claimed is:

1. A sound signal processing method for a head-mounted display apparatus, comprising:
acquiring an ambient sound signal of the head-mounted display apparatus;
identifying the ambient sound signal and determining a sound category corresponding to the ambient sound signal; and
displaying corresponding prompt information in the head-mounted display apparatus according to the sound category.

2. The sound signal processing method according to claim 1, wherein acquiring the ambient sound signal of the head-mounted display apparatus comprises:
acquiring a sound signal for a preset time duration through a sound receiving device of the head-mounted display apparatus;
detecting the acquired sound signal to obtain a sound signal with a timestamp and a confidence;
determining the sound signal as the ambient sound signal, the sound signal corresponding to a target timestamp with a confidence greater than a confidence threshold.

3. The sound signal processing method according to claim 2, wherein the sound receiving device comprises a microphone array, and
the sound signal processing method further comprises:
determining a sound direction according to the sound signal acquired by the microphone array.

4. The sound signal processing method according to claim 1, wherein identifying the ambient sound signal and determining the sound category corresponding to the ambient sound signal comprises:
comparing the ambient sound signal with a plurality of categories of sound signal samples in a preset sound database;
acquiring a target sound signal sample corresponding to the ambient sound signal; and
determining the sound category based on a category of the target sound signal sample.

5. The sound signal processing method according to claim 1, further comprising:
determining a sound level based on the ambient sound signal and a preset volume threshold; and
displaying the sound level based on the head-mounted display apparatus.

6. The sound signal processing method according to claim 3, further comprising:
determining a sound level based on the ambient sound signal and a preset volume threshold; and
displaying the sound level based on the head-mounted display apparatus.

7. The sound signal processing method according to claim 5, wherein the volume threshold comprises a first volume threshold, a second volume threshold and a third volume threshold, wherein the first volume threshold is greater than the second volume threshold, and the second volume threshold is greater than the third volume threshold;
determining the sound level based on the ambient sound signal and the preset volume threshold comprises:
determining the sound level as a first sound level in a case that a volume of the ambient sound signal is greater than the first volume threshold;
determining the sound level as a second sound level in a case that the volume of the ambient sound signal is smaller than the first volume threshold and greater than the second volume threshold; and
determining the sound level as a third sound level in a case that the volume of the ambient sound signal is smaller than the second volume threshold and greater than the third volume threshold.

8. The sound signal processing method according to claim 6, wherein the volume threshold comprises a first volume threshold, a second volume threshold and a third volume threshold, wherein the first volume threshold is greater than the second volume threshold, and the second volume threshold is greater than the third volume threshold;
determining the sound level based on the ambient sound signal and the preset volume threshold comprises:
determining the sound level as a first sound level in a case that a volume of the ambient sound signal is greater than the first volume threshold;
determining the sound level as a second sound level in a case that the volume of the ambient sound signal is smaller than the first volume threshold and greater than the second volume threshold; and
determining the sound level as a third sound level in a case that the volume of the ambient sound signal is smaller than the second volume threshold and greater than the third volume threshold.

9. The sound signal processing method according to claim 6, wherein displaying the corresponding prompt information in the head-mounted display apparatus according to the sound category comprises:
determining a sound icon and text information based on the sound category;
determining an orientation icon based on the sound direction;
determining a display color and a vibration amplitude based on the sound level; and
displaying the orientation icon, the sound icon and the text information on a display interface of the head-mounted display apparatus according to the display color, while controlling the head-mounted display apparatus to vibrate according to the vibration amplitude.

10. A sound signal processing device for a head-mounted display apparatus, comprising:
an acquisition module, configured to acquire an ambient sound signal of the head-mounted display apparatus;
a processing module, configured to identify the ambient sound signal and determine a sound category corresponding to the ambient sound signal; and
a display module, configured to display corresponding prompt information in the head-mounted display apparatus according to the sound category.

11. The sound signal processing device according to claim 10, wherein the acquisition module is further configured to:
acquire a sound signal for a preset time duration through a sound receiving device of the head-mounted display apparatus;
detect the acquired sound signal to obtain a sound signal with a timestamp and a confidence; and
determine the sound signal as the ambient sound signal, the sound signal corresponding to a target timestamp with a confidence greater than a confidence threshold.

12. The sound signal processing device according to claim 11, wherein the sound receiving device comprises a microphone array, and
the sound signal processing device further comprises:
a first determination module, configured to determine a sound direction according to the sound signal acquired by the microphone array.

13. The sound signal processing device according to claim 10, wherein the processing module is further configured to:
compare the ambient sound signal with a plurality of categories of sound signal samples in a preset sound database;
acquire a target sound signal sample corresponding to the ambient sound signal; and
determine the sound category based on a category of the target sound signal sample.

14. The sound signal processing device according to claim 10, further comprising:
a second determination module, configured to determine a sound level based on the ambient sound signal and a preset volume threshold; and
the display module is further configured to display the sound level based on the head-mounted display apparatus.

15. The sound signal processing device according to claim 12, further comprising:
a second determination module, configured to determine a sound level based on the ambient sound signal and a preset volume threshold; and
the display module is further configured to display the sound level based on the head-mounted display apparatus.

16. The sound signal processing device according to claim 14, wherein the volume threshold comprises a first volume threshold, a second volume threshold and a third volume threshold, wherein the first volume threshold is greater than the second volume threshold, and the second volume threshold is greater than the third volume threshold;
the second determination module is further configured to:
determine the sound level as a first sound level in a case that a volume of the ambient sound signal is greater than the first volume threshold;
determine the sound level as a second sound level in a case that the volume of the ambient sound signal is smaller than the first volume threshold and greater than the second volume threshold; and
determine the sound level as a third sound level in a case that the volume of the ambient sound signal is smaller than the second volume threshold and greater than the third volume threshold.

17. The sound signal processing device according to claim 15, wherein the volume threshold comprises a first volume threshold, a second volume threshold and a third volume threshold, wherein the first volume threshold is greater than the second volume threshold, and the second volume threshold is greater than the third volume threshold;
the second determination module is further configured to:
determine the sound level as a first sound level in a case that a volume of the ambient sound signal is greater than the first volume threshold;
determine the sound level as a second sound level in a case that the volume of the ambient sound signal is smaller than the first volume threshold and greater than the second volume threshold; and
determine the sound level as a third sound level in a case that the volume of the ambient sound signal is smaller than the second volume threshold and greater than the third volume threshold.

18. The sound signal processing device according to claim 15, wherein the display module is further configured to:
determine a sound icon and text information based on the sound category;
determine an orientation icon based on the sound direction;
determine a display color and a vibration amplitude based on the sound level; and
display the orientation icon, the sound icon and the text information on a display interface of the head-mounted display apparatus according to the display color, while controlling the head-mounted display apparatus to vibrate according to the vibration amplitude.

19. An electronic equipment, comprising:
a processor; and
a memory, configured for storing instructions executable by the processor,
wherein the processor is configured to read the executable instructions from the memory and execute the instructions to implement the sound signal processing method according to claim 1.
